(19) United States
(12) Patent Application Publication
(10) Pub. No.: US 2003/0148160 A1
(43) Pub. Date: Aug. 7, 2003

(54) Anode-supported tubular solid oxide fuel cell stack and method of fabricating the same

(75) Inventors: Rak-Hyun Song, Taejon (KR); Dong-Ryul Shin, Taejon (KR); Keun-Suk Song, Taejon (KR); Harumi Yokokawa, Ibaraki (JP)

Correspondence Address: DELIO & PETERSON, 121 WHITNEY AVENUE, NEW HAVEN, CT, 06510

(73) Assignee: Korea Institute of Energy Research

(21) Appl. No.: 10/335,317

(22) Filed: Jan. 2, 2003

(30) Foreign Application Priority Data
Feb. 4, 2002 (KR) 6196/2002

(51) Int. Cl. H01M 8/10; H01M 4/88

(52) U.S. Cl. 429/31; 429/32; 429/33; 427/115; 264/43; 264/618; 502/101

(57) ABSTRACT

Disclosed is an anode-supported tubular solid oxide fuel cell stack, in which a thin and dense electrolyte layer and an air electrode are coated in good order on the surface of a porous anode-supported tube extruded by use of a slurry dipping process useful in mass production of a fuel cell, thereby the stable fuel cell stack with high mechanical strength is formed, and method of fabricating the anode-supported tubular solid oxide fuel cell stack. After a plurality of unit cells for anode-supported tubular solid oxide fuel cell stacks with excellent electric conductivity and a smooth current flow are inexpensively produced, the unit cells are stacked and combined with a plurality of metal connector plates having semicircular grooves for mounting unit cells thereon to fabricate a desired fuel cell stack. The anode-supported tubular solid oxide fuel cell stack is advantageous in that the operating temperature of the fuel cell stack is reduced without reduction of performance by using an anode-supported tube, thus a relatively low-priced commercial metal is used as a connector plate, and a large capacity fuel cell is easily produced in comparison with a flat plate type fuel cell stack.

### BACKGROUND OF THE INVENTION

1. Field of the Invention

The present invention relates, in general, to an anode-supported tubular solid oxide fuel cell stack and a method of fabricating the same and, in particular, to an anode-supported tubular solid oxide fuel cell stack, in which a thin and dense electrolyte layer and an air electrode are coated in good order on the surface of a porous anode-supported tube extruded by use of a slurry dipping process useful in mass production of fuel cells, thereby the stable fuel cell stack with high mechanical strength is formed, as well as a method of fabricating such an anode-supported tubular solid oxide fuel cell stack. After a plurality of unit cells for anode-supported tubular solid oxide fuel cell stacks having an excellent electric conductivity and a smooth current flowing are inexpensively produced, the unit cells are stacked and combined with a plurality of metal connector plates having semicircular grooves for mounting the unit cells thereon, thereby fabricating a desired fuel cell stack.

2. Description of the Prior Art

A fuel cell is a high efficiency clean generator, in which hydrogen contained in a hydrocarbon based material such as natural gas, coal gas, or methanol, is electrochemically reacted with oxygen contained in air to produce electric energy. It is classified into Alkaline, Phosphoric acid, Molten carbonate, Solid oxide, and Polymer fuel cells.

Generally, the Phosphoric acid fuel cell using a phosphoric acid electrolyte is referred to as a first generation fuel cell, in which hydrogen gas mostly containing hydrogen reformed from fossil fuel and oxygen contained in air are used as fuel, the high temperature Molten carbonate fuel cell using molten carbonate as the electrolyte and operating at about 650° C. is referred to as a second generation fuel cell, and the Solid oxide fuel cell (SOFC) operating at a relatively higher temperature and generating the most highly efficient electricity is referred to as a third generation fuel cell.

The third generation fuel cell, the Solid oxide fuel cell, was developed after the Phosphoric acid fuel cell (PAFC) and the Molten carbonate fuel cell (MCFC), but it is expected that the Solid oxide fuel cell will be rapidly commercialized in subsequent to PAFC and MCFC due to a rapid development of material technology, as well much effort has been dedicated to researching the fuel cell, and a large capacity fuel cell, in developed countries.

The Solid oxide fuel cell is operated at a high temperature ranging from 600 to 1000° C., and has advantages in that it is the most highly efficient of existing fuel cells, there are few pollutants discharged, a fuel reformer is not necessary, and a combined power generation is feasible.

The solid oxide fuel cell is generally classified into a tube and a plate type fuel cell. As for the tube type fuel cell, an air electrode support type fuel cell has been developed in the USA and Japan (U.S. Pat. No. 6,207,311 and U.S. Pat. No. 5,453,330), and a self-supporting film type fuel cell comprising an electrolyte as a support and an anode-supported plate fuel cell has been developed as the plate type fuel cell (U.S. Pat. No. 6,048,636).

The plate type solid oxide fuel cell has a higher current density than a disk type fuel cell, but has disadvantages in that a large-sized plate type fuel cell necessarily needed to produce a large capacity fuel cell is difficult to produce using the plate type solid oxide fuel cell due to several problems such as sealing of gas and thermal shock due to a difference of thermal equilibrium coefficient between constituents of the fuel cell.

In comparison with the disk type solid oxide fuel cell, the tube type solid oxide fuel cell has a low current density. However, the tube type fuel cell is almost the same as the disk type fuel cell in the current density of a whole fuel cell system. In addition, the tube type solid oxide fuel cell is advantageous in that unit cells constituting the stack are easily sealed, resistance to heat stress and mechanical strength of the stack are high, thereby the tube type solid oxide fuel cell is considered as excellent technology by which the large-sized fuel cell can be most easily produced. Currently, therefore, many studies of the tube type solid oxide fuel cell are being undertaken in many companies such as Siemens-Westinghouse Company and other research institutions.

However, a conventional tube type fuel cell is an air electrode-supported fuel cell using an air electrode as the support of the fuel cell, and production cost of the fuel cell is increased because raw materials for the air electrode such as La and Mn are very expensive and production of LSM (LaSrMnO₃) is difficult. In addition, the unit cell is low in mechanical strength and does not withstand impact because the air electrode acting as the support is made of ceramics while an anode is made of cermet consisting of metals and ceramics.

Furthermore, an electrolyte layer is coated on a surface of the air electrode-supported tube by use of a EVD process (Electrochemical Vapor Deposition process) during fabrication of the conventional air electrode-supported tubular solid oxide fuel cell, and so the conventional air electrode-supported tubular solid oxide fuel cell is disadvantageous in terms of cost.

In other words, the air electrode is fragile because the air electrode is made of high-priced ceramics such as La which is used as the support in the conventional air electrode-supported tubular solid oxide fuel cell, the strength of the air electrode is reduced due to a chemical reaction, in the ceramic structure constituting the air electrode, at high temperature, and the fuel cell price is increased because the electrolyte layer is formed on the surface of the air electrode by use of the EVD process which is very costly.

Furthermore, the electrolyte and the anode formed on a surface of the sintered air electrode-supported tube are co-sintered at high temperature, and so activity of the air electrode is reduced and an efficiency of the fuel cell is lowered.

To avoid the above disadvantages of the air electrode-supported solid oxide fuel cell, the anode-supported tubular solid oxide fuel cell using the anode as the support has been developed.

The anode-supported tube used in the anode-supported tubular solid oxide fuel cell satisfies characteristics required by the electrode as well as acts as the support, and is advantageous in that co-sintering is feasible because reactivity is low between the support and the electrolyte layer, and a stable fuel cell stack can be fabricated due to high mechanical strength of the anode.

In addition, the anode-supported tube has sufficient pores therein, a fuel provision is not limited because a continuous pore distribution is formed in the anode-supported tube, and current flow is smooth due to high electric conductivity and production cost of the fuel cell is low.

When the anode-supported tubular solid oxide fuel cell is produced, the most important factor affecting productivity is a process of coating the electrolyte layer on the surface of the anode-supported tube.

In detail, a conductivity of YSZ, which is most widely used as the electrolyte in the solid oxide fuel cell, is about 10⁻¹ S/cm at 1000° C., and the electrolyte layer should have a thickness of about 30 μm or lower and be very dense because the lower an operating temperature of the fuel cell is, the lower the conductivity is or the higher a resistance is .

The anode-supported tubular solid oxide fuel cell has a disadvantage in that the very thin and dense electrolyte layer should be formed on the surface of the porous anode-supported tube with a wide surface area. Therefore, recently, many studies have been initiated in order to develop a process of efficiently forming an excellent electrolyte layer.

When the electrolyte layer is formed by a physical and chemical vapor deposition process using a vacuum such as the EVD process or a plasma spray coating process, a dense and thin electrolyte layer can be formed, but equipment used to form the electrolyte layer is large and reaction time is excessively long. In addition, the above processes are not suitable to produce the fuel cell in commercial quantities because a few of the unit cell are deposited by the electrolyte at one time.

Additionally, a new type of connector is required to connect unit cells to each other so as to form the solid oxide fuel cell stack.

Furthermore, the solid oxide fuel cell operated at a high temperature of 1000° C. has disadvantages in that it requires an expensive connector, there are difficulties in producing elements constituting the fuel cell, a sintering of electrode particles occurs when operating the fuel cell over a long term, as well as an oxidation of materials, a diffusion of an interface, and heat stress. Therefore, it is necessary to develop the solid oxide fuel cell, which is operable at a moderate temperature of 600 to 800° C. so as to secure stability for the long term.

### SUMMARY OF THE INVENTION

Therefore, it is an object of the present invention to avoid the above disadvantages of a conventional process of forming an electrolyte layer on a surface of the anode-supported tube, and provide a new type connector, an anode-supported tubular solid oxide fuel cell stack with excellent efficiency, and a method of efficiently fabricating the solid oxide fuel cell stack.

The above objects can be accomplished by provisions of a wet dipping process of forming the electrolyte layer on the anode-supported tube, useful to produce a fuel cell in commercial quantity, and metal connector plates used to efficiently stacking a plurality of tubular type unit cells.

### BRIEF DESCRIPTION OF THE DRAWINGS

The above and other objects, features and advantages of the present invention will be more clearly understood from the following detailed description taken in conjunction with the accompanying drawings, in which:

FIGS. 1a and 1b are a perspective view and a sectional view of an anode-supported tubular solid oxide unit fuel cell according to the present invention, respectively;

FIG. 2 schematically illustrates various unit cells having different production steps;

FIG. 3 illustrates X-ray diffraction patterns of anode powders and an anode-supported tube before and after hydrogen reduction;

FIG. 4 is a graph showing a pore size distribution of pores in the anode-supported tube before and after hydrogen reduction;

FIGS. 5a and 5b are SEM pictures of the anode-supported tube before and after hydrogen reduction;

FIGS. 6a to 6c are a SEM picture of the anode-supported tube, a picture illustrating an Ni-distribution image by a EDAX mapping analysis, and a picture illustrating a Zr-distribution image by the EDAX mapping analysis, respectively;

FIG. 7 is a graph showing electric conductivity as a function of temperature for the anode-supported tube of the present invention;

FIGS. 8a to 8d are pictures showing a surface structure of an electrolyte layer varied according to a dipping number and a concentration of slurry when the anode-supported tube is dipped into the slurry for the electrolyte at 22 mm/sec, in which

FIG. 8a is a picture showing the surface structure of the electrolyte layer when the anode-supported tube is dipped into the slurry containing 20 wt % of YSZ one time,

FIG. 8b is a picture showing the surface structure of the electrolyte layer when the anode-supported tube is dipped into the slurry containing 20 wt % of YSZ five times,

FIG. 8c is a picture showing the surface structure of the electrolyte layer when the anode-supported tube is dipped into the slurry containing 30 wt % of YSZ one time, and

FIG. 8d is a picture showing the surface structure of the electrolyte layer when the anode-supported tube is dipped into the slurry containing 30 wt % of YSZ five times;

FIG. 9 is a graph showing thickness of the electrolyte layer as a function of a dipping number and the concentration of the slurry for the anode-supported tube of the present invention;

FIGS. 10a to 10c are pictures showing sections of electrolyte layers when the anode-supported tube is dipped into the slurry containing 30 wt % of YSZ two times at 2 mm/sec, 22 mm/sec, and 44 mm/sec, respectively;

FIG. 11 is a graph showing a flow rate of gas penetrating the anode-supported tube as a function of atmospheric pressure for the anode-supported tube having various electrolyte layers with effective areas of 35 cm²;

FIGS. 12a and 12b are graphs showing performance of the unit cell of the present invention, in which

FIG. 12a is a graph showing a voltage and a power density as a function of a current density for the unit cell having a dense electrolyte layer, and

FIG. 12b is a graph showing the voltage and the power density as a function of the current density for the unit cell having the electrolyte layer with pinholes;

FIG. 13 is a perspective view of a middle metal connector plate used to stack the unit cells;

FIG. 14 is a sectional view of a fuel cell stack according to an embodiment of the present invention; and

FIG. 15 is a partially enlarged view of the fuel tell stack of FIG. 14, which shows a contact structure of the metal connector plates with fuel cells.

### DETAILED DESCRIPTION OF THE INVENTION

Based on the present invention, the above objects can be accomplished by provisions of a wet slurry dipping process, and metal connector plates having semicircular grooves for mounting unit cells thereon or covering unit cells, positioned on an upper and a lower side thereof.

According to the slurry dipping process, a porous anode-supported tube pre-sintered at a high temperature is dipped into a liquid electrolyte slurry to form an electrolyte slurry layer on the anode-supported tube. The electrolyte slurry layer coated on the anode-supported tube is then dried, and co-sintered to form a thin and dense electrolyte layer.

At this time, main factors affecting quality of the electrolyte slurry layer are concentration and components of slurry, the number of times the anode-supported tube is dipped into the liquid electrolyte slurry, and drying temperature. A detailed description of these factors will be given, below.

The slurry mostly comprises an organic solvent, Y₂O₃-stabilized ZrO₂ powders (hereinafter, referred to as ‘YSZ’), and an additive. It is preferable that a concentration of YSZ powders ranges from 5 to 40 wt % based on a total weight of the solvent and YSZ powders without the additive. For example, when the concentration is less than 5 wt %, a slurry layer coated on a circumferential surface of the anode-supported tube is too thin to form a dense electrolyte layer during dipping the anode-supported tube into the slurry. On the other hand, when the concentration is more than 40 wt %, the slurry layer coated on the anode-supported tube is too thick to maintain uniformity of the slurry layer.

The slurry contains YSZ powders, 5 to 12 wt % binding agents per 100 g of the YSZ powders, 5 to 15 cc plasticizers per 100 g of the YSZ powders, 1 to 3 cc homogenizing agents per 100 g of the YSZ powders, and 1 to 3 cc dispersing agents per 100 g of the YSZ powders. The binding agent, the plasticizer, the homogenizing agent, and the dispersing agent are added to the slurry in which YSZ powders are dispersed in the organic solvent, so as to improve binding force, sintering property, uniformity, and dispersibility of the slurry, and if an amount of the additive deviates from the above ranges, the slurry is not useful in the present invention.

In addition, the anode-supported tube is dipped into the slurry 2 to 5 times according to a concentration of YSZ powders in the slurry to coat the surface of the anode-supported tube with the slurry layer. If a dipping number deviates from a range of 2 to 5 times, an electrolyte layer with a suitable thickness cannot be obtained.

The resulting slurry layer is dried at 300 to 450° C. so as to minimize heat distortion of the slurry, which may occur when drying the slurry layer, and to shorten drying time of the slurry layer. For example, when the slurry layer is dried at less than 300° C., the dense electrolyte layer is not formed because additives are not sufficiently removed. On the other hand, when a drying temperature of the slurry layer is more than 450° C., the heat distortion occurring in the slurry layer causes a low quality electrolyte layer.

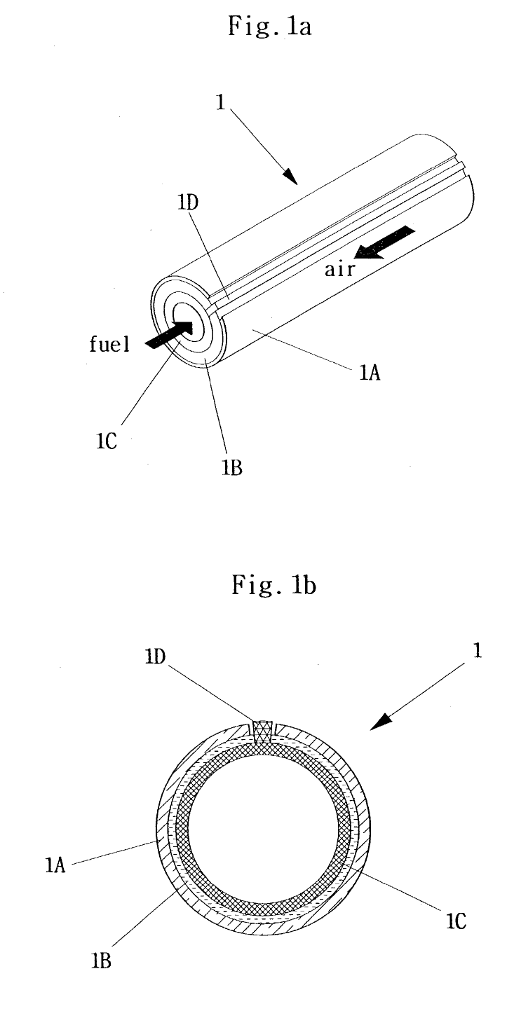

After the electrolyte layer is formed, an air electrode 1A is coated on a surface of the electrode layer 1B formed on the circumferential surface of the anode-supported tube 1C to produce a unit fuel cell 1, as shown in FIG. 1. In order to electrically connect a plurality of fuel cells to each other, each unit cell 1 is provided with a connector 1D for connecting a (−) pole, which is protruded from a circumferential surface of the anode-supported tube 1C, i.e. (−) pole, to a surface of the air electrode 1A, i.e. (+) pole, positioned at an outermost part of the unit fuel cell without contacting with the air electrode 1A, thereby a plurality of unit fuel cells form a stack.

The connector 13 consists of a ceramic material with an electronic conductivity and is longitudinally formed in a band shape on the circumferential surface of the anode-supported tube, and formed by longitudinally covering the circumferential surface of a tubular anode-supported tube with an organic film layer having a predetermined width so that a part of the circumferential surface of the anode-supported tube is not coated with electrolyte slurry, removing the organic film layer after the anode-supported tube is coated with the electrolyte slurry, and coating a ceramic connector material such as LaCaCrO₃, LaSrCrO₃, and LaMgCrO₃ on a part of the anode-supported tube which is not coated with the electrolyte slurry, by a wet process. At this time, the ceramic connector material should not be coated on the electrolyte slurry layer.

Metal connector plates for connecting unit cells with connectors to each other are made of materials with a low thermal expansion coefficient and excellent heat resistance in a temperature range of 600 to 800° C., i.e. an operation temperature range of the fuel cell, such as commercial ferrite based stainless steel and iron-chromium alloy. Metal connector plates include a lower connector plate positioned at a bottom of the anode-supported tubular solid oxide fuel cell stack, a plurality of middle connector plates, and an upper connector plate, and a surface of the metal connector plate is coated with the ceramic layer having high electronic conductivity, such as LaSrMnO₃ and LaSrCoO₃.

In addition, semicircular grooves are formed in parallel for mounting tube type fuel cells on upper sides of the lower connector plate and middle connector plates. The semicircular groove is formed on metal connector plates in such a way that a depth of the groove is slightly longer than a radius of the tube type unit cell. On the other hand, semicircular grooves are formed in parallel for covering upper parts of tube type fuel cells on lower sides of the upper connector plate and middle connector plates. At this time, the semicircular groove is formed on metal connector plates in such a way that the depth of the groove is slightly shallower than the radius of the tube type unit cell. The upper side of the upper connector plate and the lower side of the lower connector plate form flat plates.

In more detail, when the semicircular groove formed on the lower side of the metal connector plate is stacked on the semicircular groove formed on the upper side of the metal connector plate, two grooves which are opposite to each other form a groove with a circular section, and the tube type unit cell is put in this groove with the circular section formed between two metal connector plates. That is to say, the unit cell is mounted on the semicircular groove formed on the upper side of the metal connector plate, and then the semicircular groove formed on the lower side of another metal connector plate covers the upper part of the unit cell.

Furthermore, a plurality of square grooves, being at right angles to semicircular grooves, are formed in parallel on the upper and lower sides of metal connector plates, and air passes through these square grooves.

According to the present invention, there is provided a method of fabricating the anode-supported tubular solid oxide fuel cell stack, using the slurry coating procedure and the metal connector plate as described above. The method comprises the steps of providing carbon powders as a pore forming agent to a NiO-YSZ mixed powder in an amount of 20 to 50 vol % and ball-milling a resulting mixture to produce powders for an anode-supported tube; adding distilled water, organic binding agents, plasticizers, and lubricants to powders for the anode-supported tube, mixing them in a mixer, and seasoning a resulting mixture so as to uniformly disperse water in the resulting mixture to produce a paste for extrusion; extruding the paste into a tube type anode-supported tube; pre-sintering the anode-supported tube at 1250 to 1400° C.; mixing the YSZ powders with an additive in an organic solvent to produce a liquid electrolyte slurry; dipping the anode-supported tube into the liquid electrolyte slurry many times in order to produce an electrolyte slurry layer on a surface of the anode-supported tube after a band-type organic film layer is longitudinally formed on a circumferential surface of the anode-supported tube; removing the organic film layer from the anode-supported tube, drying the electrolyte slurry layer at 300 to 450° C., and co-sintering a dried electrolyte slurry layer at 1350 to 1500° C. to form a electrolyte layer; coating a ceramic connector material such as LaCaCrO3, LaSrCrO3, and LaMgCrO3 on a portion of the anode-supported tube on which the organic film layer was formed by a dipping type wet process, drying the anode-supported tube coated with the ceramic connector material at 300 to 450° C., and sintering a dried anode-supported tube at 1350 to 1500° C. to form a band-type ceramic connector; forming an organic protective film layer on a surface of the band-type ceramic connector, coating an air electrode on a surface of the electrolyte layer with the use of the liquid slurry for the air electrode containing LaSrMnO₃ powders by a dipping type slurry coating process; removing the organic protective film layer formed on the surface of the band-type ceramic connector, and sintering a resulting air electrode at 1150 to 1250° C. to complete a unit cell; and upwardly stacking metal connector plates in the order of a lower connector plate, fuel cells, middle connector plates, fuel cells, middle connector plates . . . , fuel cells, and an upper connector plate, and connecting stack electrodes to the lower connector plate and the upper connector plate, respectively. The lower connector plate is provided on only an upper side thereof with a plurality of first semicircular grooves and a plurality of first square grooves being at right angles to the first semicircular grooves, middle connector plates are each provided on an upper and a lower side thereof with a plurality of second semicircular grooves and a plurality of second square grooves being at right angles to the second semicircular grooves, and the upper connector plate is provided on only a lower side thereof with a plurality of third semicircular grooves and a plurality of third square grooves being at right angles to the third semicircular grooves.

The anode-supported tubular solid oxide fuel cell of the present invention comprises a porous anode-supported tube containing a NiO-YSZ mixed powder, and the electrolyte layer and the air electrode layer coated on a surface of the anode-supported tube by a dipping type slurry coating process. At this time, carbon added to powders for the anode-supported tube creates pores in the anode-supported tube, so that a sufficient porosity is provided in the anode-supported tube.

In other words, carbon powders contained in powders for the anode-supported tube are burnt during the presintering step of the anode-supported tube after the step of extruding powders into the anode-supported tube, and thus pores are formed inside of the anode-supported tube.

A detailed description will be given of a composition and a sintering temperature of powders for the anode-supported tube, below.

Generally, an anode acting as a site in which fuel is electrochemically reacted, should be stable in a reduction atmosphere, and have a sufficient catalytic property and electronic conductivity against fuel gas.

Accordingly, the present invention provides mixed powders of NiO containing 30 to 50 vol % of Ni metal with YSZ powders as a raw material for the anode-supported tube. At this time, an electric conductivity of a Ni/YSZ cermet depends on a Ni content. When the Ni content is 30 vol % or more, the electric conductivity is improved because contact between nickel particles is improved. However, when the Ni content is less than 30 vol %, the electronic conductivity is greatly reduced.

As described above, the electric conductivity of the anode is improved by increasing the Ni content, but when the Ni content is more than 50 vol %, a thermal expansion coefficient of the Ni/YSZ cermet is increased, and so the Ni/YSZ cermet is different from other constituents of the anode-supported tubular solid oxide fuel cell in the thermal expansion coefficient, and cracks usually occur in the fuel cell during production of the fuel cell or in evaluating fuel cell performance. According to the present invention, therefore, NiO powders containing 30 to 50 vol % of Ni metal are mixed with YSZ powders, thereby a thermal expansion coefficient difference between the Ni/YSZ cermet and other constituents of the anode-supported tubular solid oxide fuel cell is minimized, and the anode has the sufficient electric conductivity.

In addition, carbon powders contained in powders for the anode-supported tube are added as a pore forming agent to an inside of the anode-supported tube in an amount of 20 to 50 vol % during the pre-sintering step of the anode-supported tube and after the step of extruding into the anode-supported tube. For example, when the amount of carbon powders is less than 20 vol %, the anode does not operate normally because the porosity in the anode-supported tube is reduced. On the other hand, when the amount is more than 50 vol %, strength of the anode-supported tube is reduced because the porosity is excessively increased.

A paste produced by mixing nickel and YSZ with carbon powders is extruded into the anode-supported tube, and the resulting anode-supported tube is pre-sintered at 1250 to 1400° C. For example, when a pre-sintering temperature is less than 1250° C., the anode-supported tube does not have strength enough to endure the step of forming the electrolyte layer. While, when the temperature is more than 1400° C., the anode-supported tube is seriously shrunk, and so the fuel cell may be cracked due to a difference in shrinkage percentage of constituents of the fuel cell during the co-sintering step and after the anode-supported tube is coated with the slurry.

After a circumferential surface of the anode-supported tube subjected to the pre-sintering step is coated with an electrolyte slurry by a slurry coating process, co-sintering is conducted at 1350 to 1500° C., in which the slurry is sintered and the anode-supported tube is subjected to a secondary sintering. When the co-sintering temperature is lower than 1350° C., the anode-supported tube and the electrolyte layer are not sufficiently sintered, and when the co-sintering temperature is higher than 1500° C., microstructure characteristics of the anode-supported tube and the electrolyte layer are undesirable because the electrolyte layer is excessively sintered.

After the co-sintering is completed, an air electrode slurry is coated on a surface of the electrolyte layer, and the air electrode slurry layer is sintered at 1150 to 1250° C. For example, when the air electrode slurry layer is sintered at lower than 1150° C., the air electrode slurry is not sufficiently sintered. On the other hand, when the sintering temperature of the air electrode slurry layer is higher than 1250° C., Mn element in the air electrode is lost due to an excess sintering and the microstructure characteristics of the air electrode become undesirable.

A better understanding of the present invention may be obtained in light of the following examples which are set forth to illustrate, but are not to be construed to limit the present invention.

### Production of the Anode-Supported Tube

In order to produce anode powders of 40 vol % of Ni/YSZ cermet, NiO was mixed with 8 mol % of Y₂O₃-stabilized-ZrO₂ powders. Mixed powders were subjected to a ball-milling process for 24 hours with the use of highly pure zirconia balls, and ethanol as a ball-milling medium was added to the resulting powders. The powders containing ethanol were then subjected to a wet ball-milling process for 24 hours, dried on a hot plate, and pulverized. Pulverized powders were heat treated at 550° C. for 3 hours, and pulverized again to produce anode powders.

An activated carbon was used as a pore forming agent. 35 vol % of the activated carbon was mixed with the anode powders, and then subjected to the wet ball-milling process for 14 days so as to uniformly mix the activated carbon with the anode powders. The resulting mixed powders were mixed with 25 wt % of distilled water, 13 wt % of an organic binding agent, 8 wt % of a plasticizer, and 3 wt % of cellosol as a lubricating agent in a mixer, and seasoned at room temperature for 24 hours so as to uniformly disperse water in mixed powders thus producing a paste for extrusion.

The paste for extrusion was extruded into a cylindrical tube with an outer diameter of 21 mm and a thickness of 2.25 mm, rolling-dried at room temperature for 24 hours, heat treated at 550° C. for 5 hours, at 750° C. for 3 hours, and at 950° C. for 3 hours in order to completely remove distilled water, the binding agent, and the pore forming agent, and subjected to the pre-sintering step at 1300° C. for 3 hours to produce a porous anode-supported tube with the electrolyte for supporting another constituent of the fuel cell.

After the electrolyte slurry layer was coated on the anode-supported tube, the Ni/YSZ cermet anode-supported tube was co-sintered at 1400° C., thereby the anode-supported tube was finally sintered. The sintered Ni/YSZ cermet anode-supported tube has a high strength, thereby form a stable stack, but because its thickness is 1.7 mm, the anode-supported tube should have 30 to 40% porosity and pores in the anode-supported tube should form a continuous pore distribution allowing the anode-supported tube to act as a gas diffusion layer.

In particular, electrochemical properties of the anode-supported tube depend on size, and a relative fraction of Ni, YSZ, and pores, and a connectivity between particles of Ni and YSZ.

The sintered anode-supported tube was reduced at 700° C. under a hydrogen atmosphere in order to evaluate characteristics of the anode-supported tube. At this time, analysis of the anode-supported tube by X-ray diffractometry confirmed that NiO was reduced to Ni. Porosity and pore size were measured by a Mercury porosimeter, pores, Zr, and Ni distributions were confirmed by SEM (Scanning Electron Microscope).

The electric conductivity of the anode-supported tube was measured by a 4 probe process while hydrogen flowed through the anode-supported tube at 600 to 800° C. at a flow rate of 0.3 l/min.

### Formation of the Electrolyte Layer

An electrolyte slurry containing 20 wt % of YSZ and the electrolyte slurry containing 30 wt % of YSZ were produced by controlling an amount of solvent. 15 g of PVB as the binding agent, 15 cc of dibutyl phthalate as the plasticizer, 3 cc of Triton-X as the homogenizing agent, and 3 cc of Fish oil as the dispersing agent were added to 150 g of YSZ. In addition, toluene and 2-propanol were added to the electrolyte slurry containing 20 wt % of YSZ in amounts of 252 cc and 504 cc, respectively, and toluene and 2-propanol were added to the electrolyte slurry containing 30 wt % of YSZ in amounts of 120 cc and 240 cc, respectively, then each mixture was subjected to the ball-milling step. After being pre-sintered, the anode-supported tube was dipped into slurries containing 20 wt % and 30 wt % of YSZ at a dipping speed of 2, 22, and 44 mm/sec with its one terminal end being closed, and 1, 2, 3, and 5 times at every dipping speed. After that, the resulting anode-supported tube was dried at 350° C., and co-sintered at 1400° C. Then a thickness and surface state of the electrolyte layer were observed. The electrolyte layer with the thickness of 30 μm or less and an effective area of 35 cm² was measured under an air atmosphere of 4 atm or lower in a gas permeability.

### Performance Evaluation of the Electrolyte Layer

The electrolyte layer serves to separate fuel from an oxidizing agent transmitting oxygen ions between the air electrode and the anode, and thus it should be very dense.

To evaluate performance of the electrolyte layer, the air electrode was coated on the dense electrolyte layer with the thickness of 30 μm and on the electrolyte layer with the thickness of 30 μm containing pinholes and open pores, and OCV (open circuit voltage) and performance of a unit cell were evaluated.

Starting materials such as La₂O₃, SrO, and MnO₂ were reacted with each other by a solid state reaction process to produce (La_{0.85}Sr_{0.15})_{0.9}MnO₃ (LSM) powders, and a 20 wt % LSM slurry was produced by the same procedure as the YSZ slurry. The electrolyte layer was dipped into the resulting LSM slurry 4 times, and heat treated at 1200° C. to produce the air electrode.

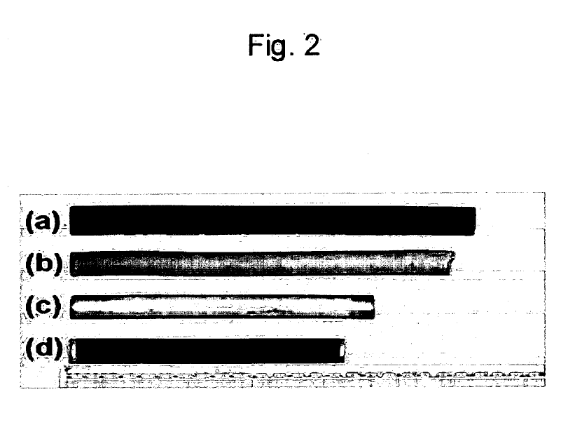

With reference to FIG. 2, unit cells produced using an extruded tube a, an anode-supported tube b, an electrolyte coated tube c, and an air electrode d by a wet process are illustrated.

In order to evaluate performance of the unit cell, Ni-felts and Pt wires were attached to the anode as a current collective body, Pt-meshes and Pt-wires were attached to the air electrode, O-rings made of Au were put in an alumina frame, and the unit cell was pressed so that the anode and the air electrode were tightly sealed.

The alumina frame and the unit cell were put in a stainless steel frame at a high temperature, and the resulting structure was tightly sealed such that air might flow along the unit cell. Thereafter, performance of the unit cell was evaluated from 650 to 900° C.

In detail, a change of voltage of the unit cell was measured with changing of a current density in the unit cell with the use of a DC electric load and a power supply, thereby performance of the unit cell was evaluated. Hydrogen containing 3% of moisture was used as fuel, air was used as the oxidizing agent, and amounts of hydrogen and air were 0.7 l/min and 1.5 l/min, respectively.

### Characteristics Evaluation of the Anode-Supported Tube

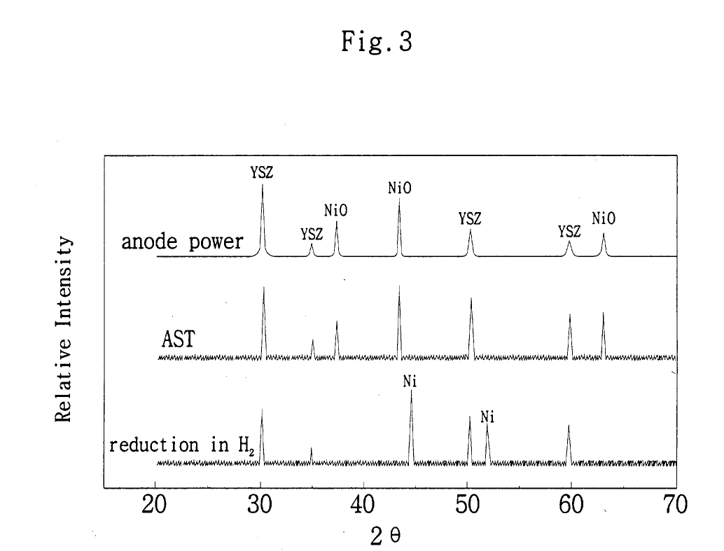

Referring to FIG. 3, X-ray diffraction patterns of anode powders and an anode-supported tube before and after hydrogen reduction are illustrated.

From the results in FIG. 3, it can be seen that the anode powder is almost the same as the extruded anode-supported tube (AST) in composition, but a NiO peak does not appear and a Ni peak makes an appearance. The reason for this is that the anode-supported tube sintered at 1400° C. was reduced at 700° C.

That is to say, when hydrogen flows through the anode-supported tube at a flow rate of 0.65 l/min at 700° C. for 3 hours, a NiO-YSZ composite is completely phase-shifted into the Ni/YSZ cermet. Therefore, the anode-supported tube is capable of being used to test performance of the unit cell after the electrolyte and the air electrode is coated on the anode-supported tube without a complicated reduction treatment.

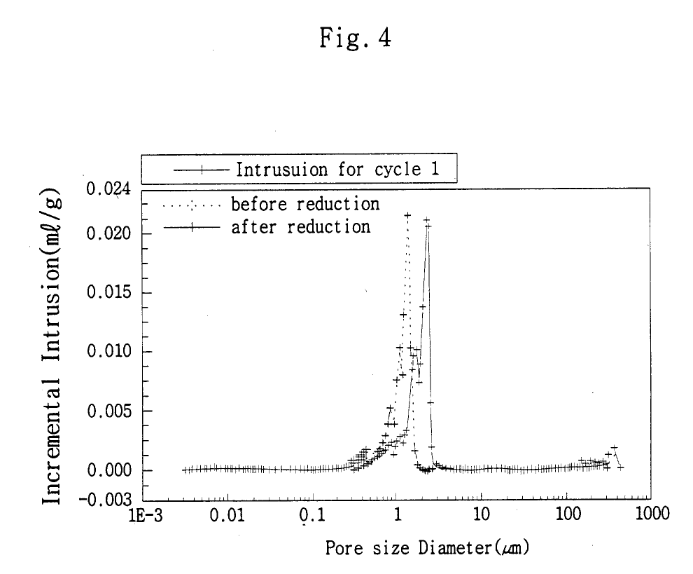

Turning to FIG. 4, a graph showing a pore size distribution in the anode-supported tube before and after hydrogen reduction is illustrated. Pores in the anode-supported tube are formed during heat treatment and reduction treatment for removing the activated carbon and additives. A porosity of the anode-supported tube sintered at 1400° C. was 42%. On the other hand, when the anode-supported tube was reduced under a hydrogen atmosphere, the porosity was increased by about 12%, i.e. the porosity was increased to 54%, and an average size of pores in the anode-supported tube increased from 1.18 μm to 1.96 μm.

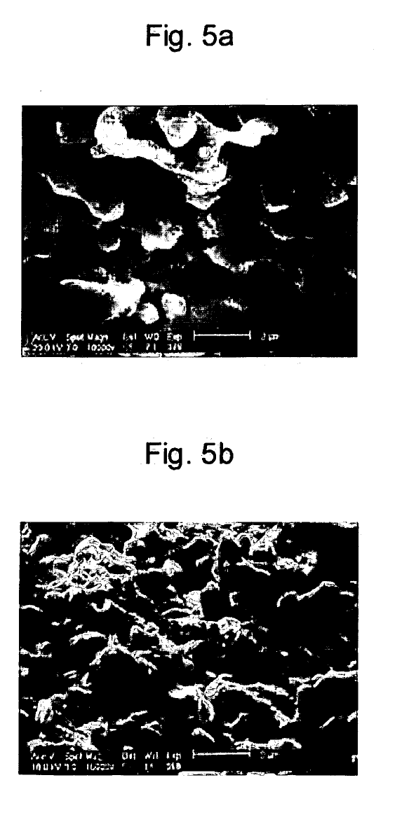

FIGS. 5a and 5b are SEM pictures of the anode-supported tube before and after hydrogen reduction. After reduction treatment of the anode-supported tube, spherical NiO is changed into polygonal NiO, as shown in FIGS. 5a and 5b. The reason for this is that when NiO is reduced to Ni, oxygen is separated from NiO and pores form in a site in which oxygen occupies. When a connectivity between Ni grains is cut, an electrode reacting area is reduced, and so an electric conductivity of the anode-supported tube is not constantly maintained and pores of the anode-supported tube form a network structure in conjunction with YSZ, thereby the crystal grain growth of Ni is controlled. In FIGS. 5a and 5b, size of the Ni grain was about 2.5 to 3 μm, and the crystal grain growth of Ni did not occur.

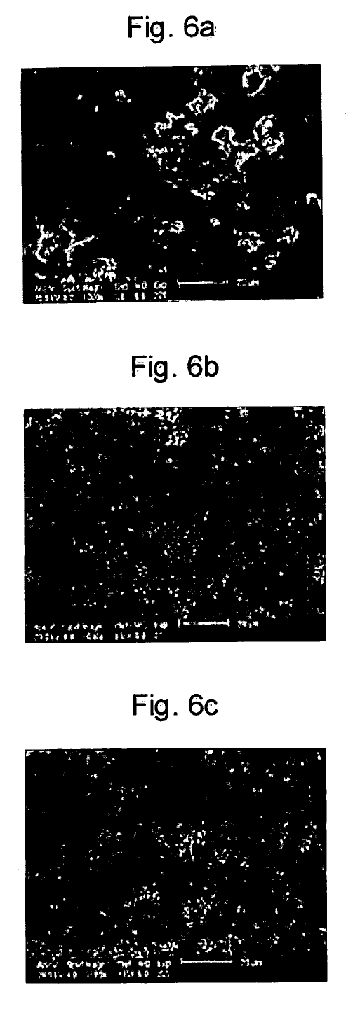

In FIG. 6a, bright portions in a SEM picture indicate pores. Relative fractions, spatial distributions, and connectivities between grains of Ni (FIG. 6b) and Zr (FIG. 6c) were confirmed by a EDAX mapping analysis, each phase are uniformly distributed in the anode-supported tube and, in particular, the connectivity between Ni-Ni grains is excellent.

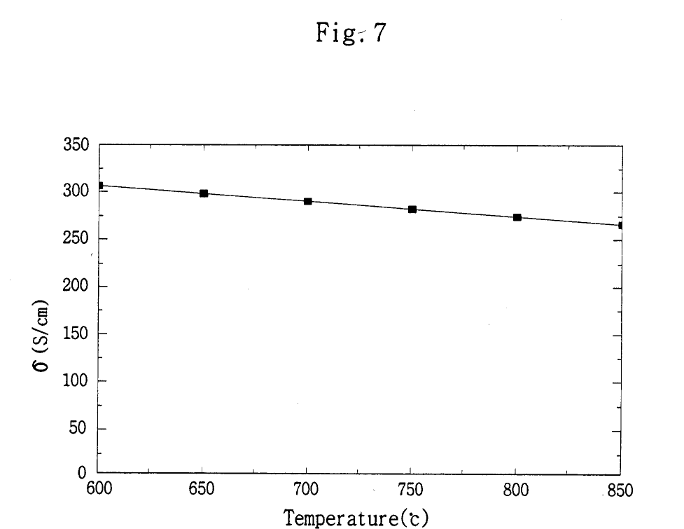

The electric conductivity of the anode-supported tube is in inverse proportion to temperature, as shown in FIG. 7, and closely relates to the connectivity between Ni-Ni grains. The anode-supported tube of the present invention is excellent in the connectivity between Ni-Ni grains and the electric conductivity characteristics according to a metal conductive mechanism, and so the anode-supported tube has the high electric conductivity of 306 to 274 S/cm at 600 to 800° C. and serves to allow for the smooth flow of electrons occurring in a reduction reaction of fuel.

### Thickness Change and Gas Permeability of the Electrolyte Layer

A thickness of a liquid slurry film, t is expressed as equation 1 when an infinite plate is upwardly pulled from the slurry after the infinite plate is dipped into plenty of slurry so as to coat the infinite plate with the slurry, on the assumption that an ideal boundary effect does not exist.

$$t = 0.944 {( \frac{η U}{γ} )}^{1 / 6} {( \frac{η U}{ρ g} )}^{1 / 2} \qquad Equation 1$$

wherein, η is a slurry viscosity, U is a dipping speed, γ is a surface tension of a solution, ρ is a slurry density, and g is an acceleration of gravity.

As is apparent from equation 1, the thickness of the liquid film is in proportion to (η^{U})^{2/3}. That is to say, the liquid film becomes thicker as the dipping speed and the slurry viscosity increase.

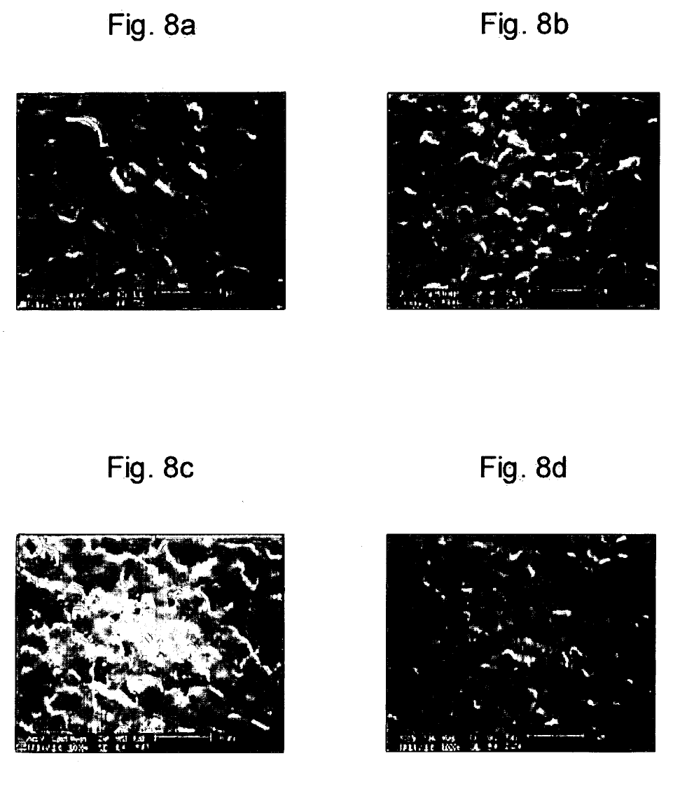

In FIGS. 8a to 8d, illustrated are surfaces microstructure of the sintered electrolyte layer after the pre-sintered anode-supported tube was dipped into the slurry containing 20 wt % of YSZ and the slurry containing 30 wt % YSZ at the dipping speed of 22 mm/sec, 1, 2, 3, and 5 times (FIG. 8a, 8b, 8c, and 8d).

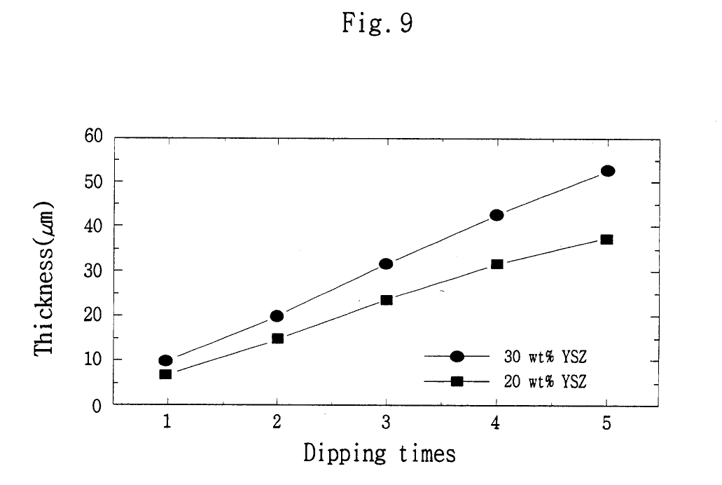

FIG. 9 is a graph showing thickness of the electrolyte layer as a function of a dipping number and the concentration of the slurry for the anode-supported tube of the present invention. The electrolyte layer coated with the slurry containing 30 wt % YSZ was thicker than the electrolyte layer coated with the slurry containing 20 wt % YSZ and had a dense surface without open pores. When the electrolyte layer was dipped into the slurry one time, the electrolyte layer had many pores. On the other hand, open ,pores in the anode-supported tube were closed as the number of dipping of the electrolyte layer into the slurry increased, and so when the electrolyte layer was dipped into the slurry five times, a surface of the electrolyte layer became dense. Therefore, it can be seen that the more often the electrolyte layer was dipped into the slurry, the thicker the electrolyte layer was.

The slurry containing 30 wt % YSZ with a higher slurry viscosity than the slurry containing 20 wt % YSZ was used to measure the thickness change of the slurry layer according to the dipping speed.

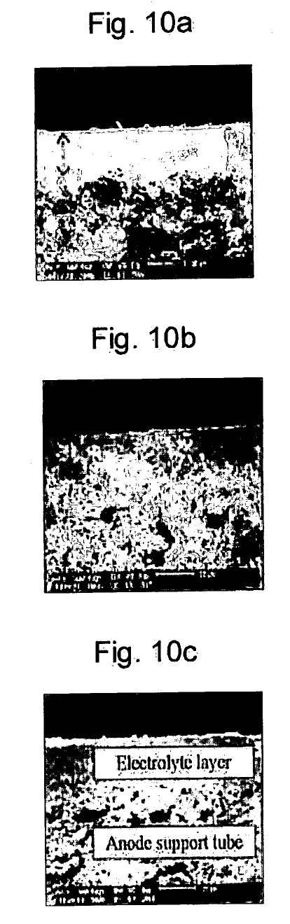

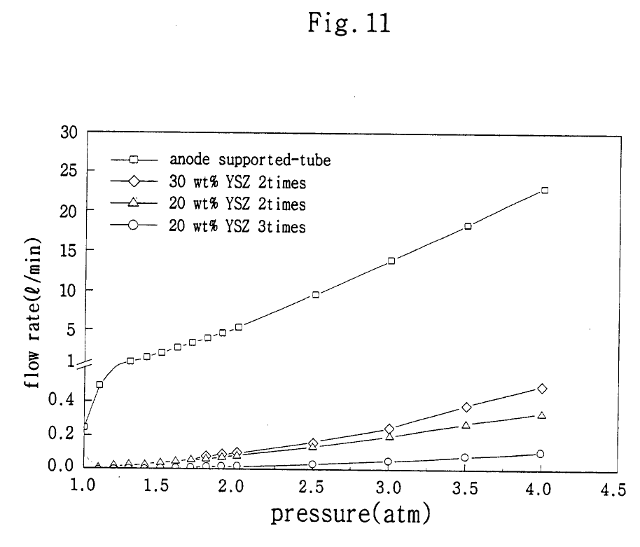

FIGS. 10a to 10c are pictures showing sections of electrolyte layers when the anode-supported tube is dipped into the slurry containing 30 wt % of YSZ two times at 2, 22, and 44 mm/sec, respectively. The thickness of the slurry layer according to the dipping speed was measured by use of SEM pictures of FIGS. 10a to 10c. Slurry layers formed by dipping the anode-supported tube into the slurry 2 times at 2, 22, and 44 mm/sec (FIG. 10a, 10b, and 10c) all had thicknesses of 20 μm. The reason is thought to be the boundary effect of the cylindrical tube.

To test the gas permeability, the electrolyte layer with the thickness of about 30 μm was provided. With reference to FIG. 11, illustrated is a graph showing a flow rate, i.e. the gas permeability, of gas penetrating the anode-supported tube as a function of atmospheric pressure for the anode-supported tube having various electrolyte layers. The anode-supported tube was sintered at 1400° C., the electrolyte layer was coated on the anode-supported tube.

The anode-supported tube according to the present invention had the gas permeability sufficient to provide fuel gas to the unit cell, that is to say, the gas permeability was 0.25 l/min under atmospheric pressure and 23 l/min under 4 pressure.

Gas permeabilities of the anode-supported tube having the electrolyte layer produced by coating the anode-supported tube with the slurry containing 20 wt % YSZ 2 and 3 times were 0.34 l/min and 0.11 l/min, respectively, and the anode-supported tube having the electrolyte layer produced by coating the anode-supported tube with the slurry containing 30 wt % YSZ two times had the gas permeability of 0.5 l/min. Accordingly, it can be seen that if the anode-supported tube is coated with the slurry containing 20 wt % YSZ several times and then sintered, the crystal grain growth and densification of YSZ occur and open pores in the electrolyte layer are sufficiently closed, and so pinholes and cracks do not form in the electrolyte layer and the electrolyte layer becomes very dense.

Performance of the Unit Cell

When reactant gas is provided to the solid oxide fuel cell, Nernst potential, i.e. an electrochemical potential difference, is formed between the anode and the air electrode, and so an electrochemical driving force occurs in the fuel cell.

The driving force without flowing of current, i.e. thermodynamic open circuit voltage, depends on a difference of oxygen partial pressure between the anode and the air electrode, and is expressed as Nernst equation, equation 2.

$${E}_{r} = 1.2746 - {[ 2.84 \times {10}^{- 4} - 2.154 \times {10}^{- 5} ln {P}_{{O}_{2 ( c )}} - 4.308 \times {10}^{15} ln \frac{{P}_{{H}_{2 ( a )}}}{{P}_{{H}_{2} {O}_{( a )}}} ]}^{T} \qquad Equation 2$$

wherein, P_{O}_{_{2(c)}} is an oxygen partial pressure of the air electrode, P_{H}_{₂₍ₐ₎} and P_{H}_{₂}_{O}_{₍ₐ₎} are partial pressures of hydrogen and vapor of the anode, respectively.

As is apparent from equation 2, the open circuit voltage is reduced as temperature increases.

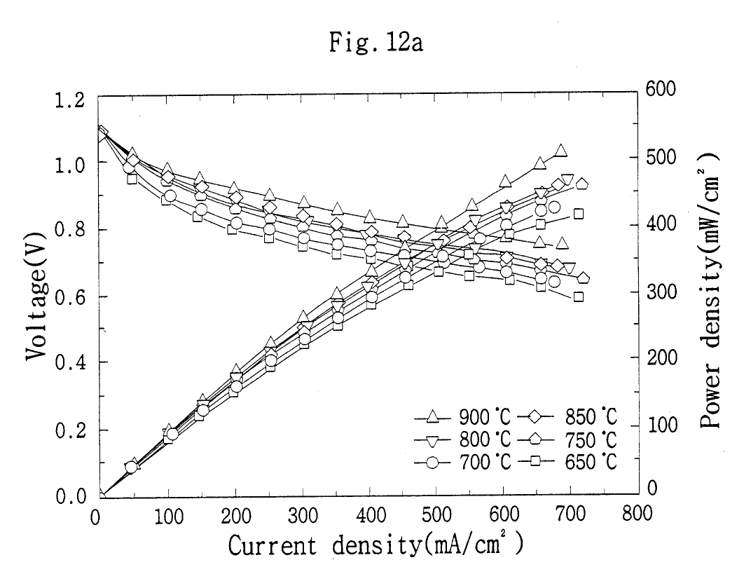

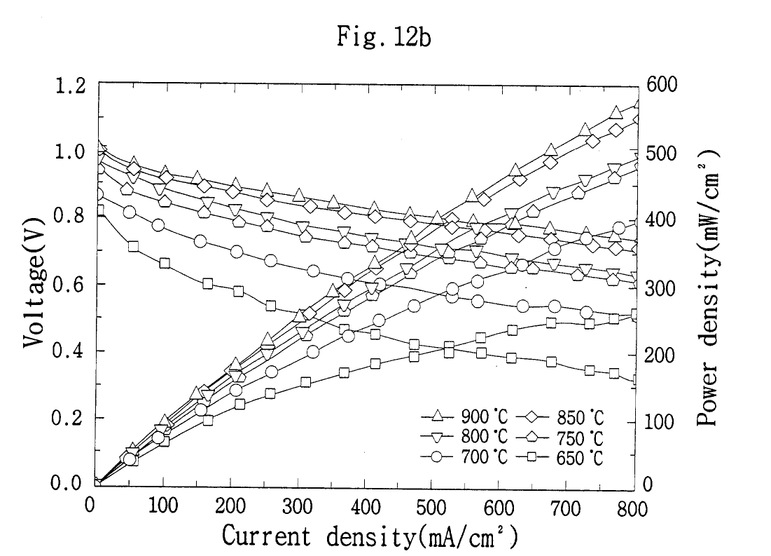

FIGS. 12a and 12b are graphs showing performances of unit cells with the dense electrolyte layer (FIG. 12a), and pinholes and open pores (FIG. 12b), respectively. In FIG. 12a, the open circuit voltage is very large, i.e. 1.07 V or higher, at every operating temperature, and reduced with increasing of the temperature. On the other hand, referring to FIG. 12b, the open circuit voltage is lower than that of FIG. 12a at every operating temperature because hydrogen and oxygen pressure are reduced due to a mixing of reactant gases passing through pinholes and open pores, but is increased as temperature increases. It is thought that the above characteristics of the unit cell in FIG. 12b are caused by pinholes and open pores in the electrolyte.

Open circuit voltage and power density values at a current density of 657 mA/cm² in FIGS. 12a and 12b are listed in Table 1.

TABLE 1

| | Unit cell with the dense | | Unit cell with pinholes and | |
|---|---|---|---|---|
| | electrolyte layer | | open pores | |
| Temp. | Open | Power | Open circuit | Power |
| (° C.) | circuit voltage (V) | density (mW/cm²) | voltage (V) | density (mW/cm²) |
| 900 | 1.0792 | 492 | 1.0150 | 490 |
| 850 | 1.0880 | 450 | 1.0097 | 487 |
| 800 | 1.1089 | 450 | 0.9901 | 443 |
| 750 | 1.1185 | 438 | 0.9294 | 411 |
| 700 | 1.1202 | 422 | 0.8860 | 357 |
| 650 | 1.1097 | 403 | 0.8175 | 245 |

From the results shown in Table 1, it can be seen that the unit cell comprising the electrolyte layer with pinholes and open pores had the open circuit voltage of 1 V and the excellent power density of 400 mW/cm² or higher at the operating temperature of 800° C. or higher, and the open circuit voltage and the power density rapidly reduced at 800° C. or lower. On the other hand, the unit cell comprising the anode-supported tube and the dense electrolyte layer had the excellent power density of 400 mW/cm² or higher at every operating temperature. Therefore, the later performs much better than the former.

Meanwhile, metal connector plates used to form a fuel cell stack of the present invention consist of an upper connector plate positioned at a top of the fuel cell stack, a lower connector plate positioned at a bottom of the fuel cell stack, and a plurality of middle connector plates positioned in conjunction with fuel cells between the upper connector plate and the lower connector plate. The upper and the lower connector plate each have semicircular grooves positioned on only one side thereof, but middle connector plates each provided on an upper and a lower side thereof with semicircular grooves.

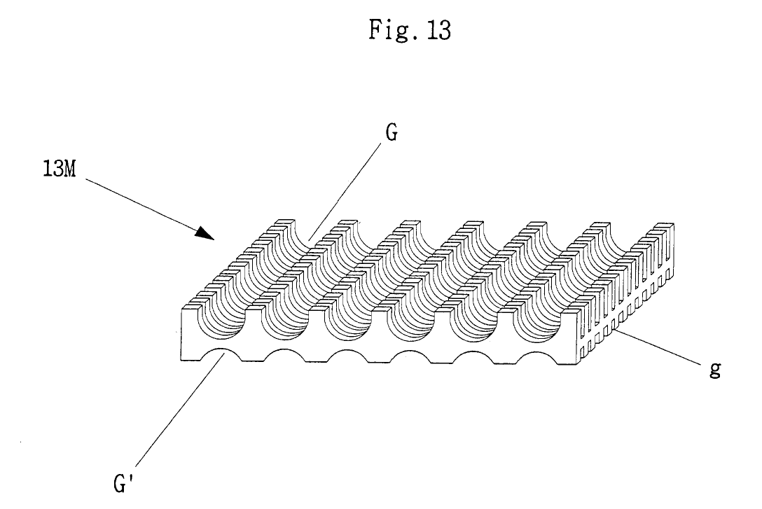

As shown in FIG. 13, the middle connector plate 13M is provided with a plurality of semicircular grooves G and a plurality of square grooves g. Square grooves g being at right angles to semicircular grooves G are formed in parallel on the upper side and the lower side of the middle connector plate, and air passes through these square grooves g.

In addition, the semicircular groove G in contact with a lower part of the air electrode of a gas flow path so as to effectively collect current of the air electrode is formed on an upper side of each metal connector plate in such a way that a depth of the groove is as great or longer than a radius of the tube type unit cell so as to expand a contacting area between the air electrode and gas much as possible. On the other hand, semicircular grooves G′ in contact with other connector plate are formed in parallel on the lower side of the middle connector plate 13M in such a way that the depth of the groove is shallower than the radius of the tube type unit cell.

Furthermore, because the metal connector plate made of commercial materials is oxidized at the operating temperature of the fuel cell, a conductive ceramic layer is coated on a surface of the metal connector plate so as to prevent an oxide film with an insulation property from being formed. The conductive ceramic layer is coated on the metal connector plate by a wet slurry coating process or a vacuum plasma spraying coating process.

In the case of using the slurry coating process, the conductive ceramic layer is sintered after it is coated on the metal connector plate. At this time, a surface of the metal connector plate is readily oxidized, and so the conductive ceramic layer should be sintered under an inert atmosphere or a reducing atmosphere using argon or hydrogen. On the other hand, when the conductive ceramic layer is coated on the metal connector plate by the vacuum plasma spraying coating process, an oxide film is not readily formed.

Because the metal connector plate has square grooves, air flows smoothly, and heat occurring in an electrochemical reaction is effectively dispersed and thus non-uniform heat stress is reduced. Furthermore, current flows smoothly and is effectively collected, and assembly structure of the fuel cell stack becomes simple, and so electricity can be generated in great quantities.

To increase an amount of electricity generated from the fuel cell stack of the present invention, the number and a length of the tube type unit cells connected to each other in parallel on the metal connector plate should be increased.

On the other hand, the number of unit cells connected to each other in series should be increased in order to obtain a high voltage from the fuel cell stack. The number of unit cells is increased by increasing of the number of metal connector plates.

The electrochemical reaction occurring in the anode-supported tubular solid oxide fuel cell stack of the present invention progresses according to a following procedure.

Hydrogen feeding to an inside of the hollow tube type fuel cell is converted into a hydrogen ion while providing an electron to the anode acting as a support and an electrode, and the electron provided to the anode is transported to an air electrode of the unit cell through a band-type ceramic connector and the metal connector plate to ionize an oxygen molecule. Oxygen ions are transported to the anode passing through the electrolyte and reacted with hydrogen ions at the anode to produce water, thereby a fuel cell reaction is completed. The above reaction is repeated in stacked unit cells, and so electricity and heat are produced from the fuel cell stack.

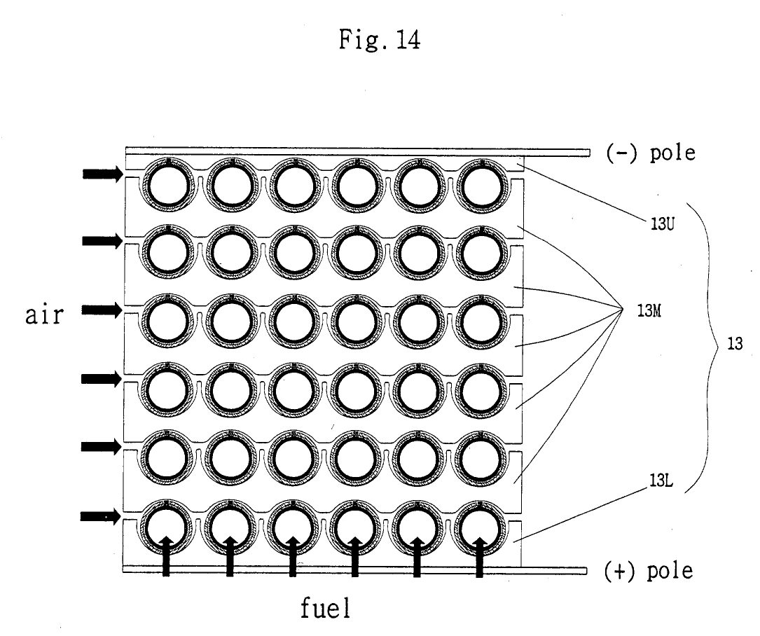

Turning now to FIG. 14, a sectional view of a fuel cell stack according to an embodiment of the present invention is illustrated. The Fuel cell stack is designed in such a way that hydrogen gas flows to an inside of the anode-supported tube 14 of the unit cell 1 and air flows through square grooves formed on the metal connector plate 13, and so hydrogen and air flow in cross. In addition, six unit cells are connected to each other in parallel through the lower side of the lower connector plate 13L to collect electricity producing in the air electrode, and the anode is connected to the air electrode in series through the upper connector plate 13U in contact with the connector of the unit cell.

Six structures each having six unit cells connected to each other in parallel are stacked using the metal connector plate to produce a fuel cell stack structure comprising 36 unit cells. A capacity of the fuel cell stack is controlled by varying the numbers of unit cells connected to each other in parallel and in series.

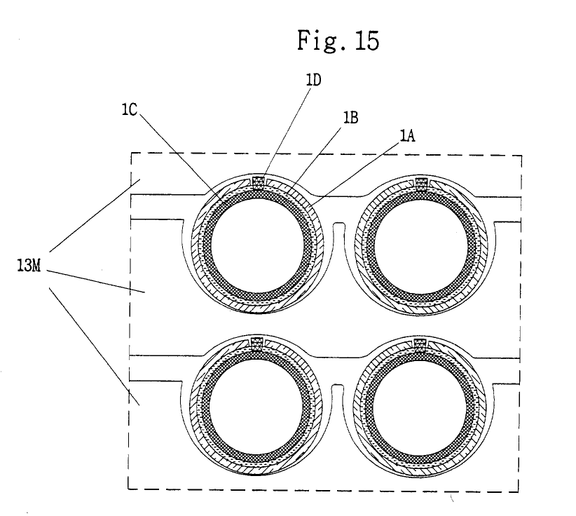

FIG. 15 is a partially enlarged view of the fuel cell stack of FIG. 14, which shows a contact structure of the metal connector plates with unit cells. In FIG. 15, the air electrode 1A coated on a surface of the tube type unit cell is in contact with the upper side of the metal connector plate 13M, and a band-type ceramic connector 1D coated on the tube type unit cell is in contact with the lower side of the neighboring metal connector plate, thereby electricity completely flows through the tube type unit cell.

When the band-type ceramic connector 1D is in contact with the lower side of the neighboring metal connector plate, the air electrode part adjacent to the ceramic connector should not be in contact with the lower side of the metal connector plate. If the lower side of the metal connector plate is simultaneously in contact with the air electrode and the ceramic connector, the fuel cell stack cannot act as a generator because of an electric short circuit.

As described above, an anode-supported tubular solid oxide fuel cell stack of the present invention is advantageous in that an operating temperature of the fuel cell stack is reduced without reduction of performance of the fuel cell stack by using an anode-supported tube, thus a relatively low-priced commercial metal is used as the connector plate, and a large capacity fuel cell is easily produced in comparison with a flat plate type fuel cell stack.

Furthermore, in comparison with the fuel cell produced by use of a conventional electrolyte layer forming process, the fuel cell of the present invention has advantages of economical and mass production because a cermet consisting of metals and ceramics is used as a raw material of an anode acting as a support, and an electrolyte layer is formed as a dense, thin film on a surface of the anode-supported tube according to a wet slurry coating process.

Other advantages of the fuel cell of the present invention are that strength of the anode is improved because a metal component of the anode forms a network type structure in ceramic at the operating temperature of the fuel cell, and production cost of the fuel cell is reduced without reduction of performance of the solid oxide fuel cell because the anode has a porous structure and fuel gas easily permeates to the anode.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. An anode-supported tubular solid oxide fuel cell stack, comprising:
a plurality of anode-supported fuel cells, in each of which an electrolyte layer is formed on a circumferential surface of an anode-supported tube, an air electrode is coated on a circumferential surface of the electrolyte layer, and a ceramic connector is longitudinally formed in a band shape on the circumferential surface of the anode-supported tube and protruded outside the air electrode without contacting with the air electrode, said electrolyte layer consisting of a mixture of 60 to 95 wt % of an organic solvent with 5 to 40 wt % of YSZ powders, 5 to 12 wt % binding agent per 100 g of the YSZ powders, 5 to 15 cc plasticizer per 100 g of the YSZ powders, 1 to 3 cc homogenizing agent per 100 g of the YSZ powders, and 1 to 3 cc dispersing agent per 100 g of the YSZ powders, said anode-supported tube consisting of mixed powders of NiO containing 30 to 50 vol % of Ni metal with the YSZ powders and 20 to 50 vol % of carbon powders used as a pore forming agent;
a plurality of metal connector plates each having a conductive ceramic layer coated on a surface thereof, said metal connector plates consisting of a lower connector plate, middle connector plates, and an upper connector plate, said lower connector plate positioned on a bottom of the anode-supported tubular solid oxide fuel cell stack and provided on only an upper side thereof with a plurality of first semicircular grooves and a plurality of first square grooves being at right angles to the first semicircular grooves, said middle connector plates each provided on an upper and a lower side thereof with a plurality of second semicircular grooves for covering upper portions of fuel, cells and supporting lower portions of the fuel cells and a plurality of second square grooves being at right angles to the second semicircular grooves, said upper connector plate forming a top of the anode-supported tubular solid oxide fuel cell stack and provided on only a lower side thereof with a plurality of third semicircular grooves for covering the upper portions of the fuel cells and a plurality of third square grooves being at right angles to the third semicircular grooves; and
electrodes connected to the upper connector plate and the lower connector plate, respectively.

2. The anode-supported tubular solid oxide fuel cell stack according to claim 1, wherein a material of the ceramic connector is selected from the group consisting of LaCaCrO₃, LaSrCrO₃, and LaMgCrO₃.

3. The anode-supported tubular solid oxide fuel cell stack according to claim 1, wherein the metal connector plates are each selected from the group consisting of commercial ferrite based stainless steel and iron-chromium alloy.

4. The anode-supported tubular solid oxide fuel cell stack according to claim 1, wherein the conductive ceramic layer formed on each of the metal connector plates is selected from the group consisting of LaSrMnO₃ and LaSrCoO₃.

5. A method of fabricating an anode-supported tubular solid oxide fuel cell stack, comprising the steps of:
providing carbon powders as a pore forming agent to mixed powders of NiO containing 30 to 50 vol % of Ni metal with YSZ powders in an amount of 20 to 50 vol % and ball-milling a resulting mixture to produce powders for an anode-supported tube;
adding distilled- water, organic binding agents, plasticizers, and lubricants to the powders for the anode-supported tube, mixing them in a mixer so as to provide an extrusion property to the powders for the anode-supported tube, and seasoning a resulting mixture so as to uniformly disperse water in the resulting mixture to produce a paste for extrusion;
extruding the paste into the anode-supported tube;
pre-sintering the anode-supported tube at 1250 to 1400° C.;
mixing the YSZ powders with an additive in an organic solvent to produce an electrolyte slurry;
dipping the anode-supported tube into the electrolyte slurry to coat an electrolyte slurry layer on a surface of the anode-supported tube after a band-type organic film layer is longitudinally formed on a circumferential surface of the anode-supported tube;
removing the organic film layer from the anode-supported tube, drying the electrolyte slurry layer at 300 to 450° C., and sintering a dried electrolyte slurry layer at 1350 to 1500° C to form an electrolyte layer;
coating a ceramic connector material with an electronic conductivity on a portion of the anode-supported tube in which the organic film layer was formed by a dipping type wet process;
drying the anode-supported tube covered with a band-type ceramic connector material at 300 to 450° C. and sintering a dried anode-supported tube at 1350 to 1500° C. to form a band-type ceramic connector;
covering an organic protective film layer on a surface of the band-type ceramic connector, coating an air electrode on a surface of the electrolyte layer with the use of the liquid slurry for the air electrode containing LaSrMnO₃ powders by a dipping type slurry coating process;
removing the organic protective film layer formed on the surface of the band-type ceramic connector, and sintering a resulting air electrode at 1150 to 1250° C. to complete a unit cell; and
upwardly stacking metal connector plates in the order of a lower connector plate, a fuel cell, middle connector plates, a fuel cell, and an upper connector plate, and connecting stack electrodes to the lower connector plate and the upper connector plate, respectively, said lower connector plate provided on only an upper side thereof with a plurality of first semicircular grooves and a plurality of first square grooves being at right angles to the first semicircular grooves, said middle connector plates each provided on an upper and a lower side thereof with a plurality of second semicircular grooves and a plurality of second square grooves being at right angles to the second semicircular grooves, said upper connector plate provided on only a lower side thereof with a plurality of third semicircular grooves and a plurality of third square grooves being at right angles to the third semicircular grooves.

6. The method according to claim 5, wherein the ceramic connector material is selected from the group consisting of LaCaCrO₃, LaSrCrO₃, and LaMgCrO₃, and covered on the anode-supported tube by a wet dipping process.

7. The method according to claim 5, wherein the electrolyte slurry layer is coated on the anode-supported tube by using a wet dipping process 2 to 5 times.
